(19) United States
(12) Patent Application Publication
(10) Pub. No.: US 2024/0160185 A1
(43) Pub. Date: May 16, 2024

(54) PORTABLE CNC MACHINE AND MACHINING METHOD USING SAME

(71) Applicant: Force Precision Instrument Co, Ltd., New Taipei City (TW)

(72) Inventors: Ren-Yu Yeh, New Taipei City (TW); Po-Hsiang Yu, New Taipei City (TW); Chih-Wen Cheng, New Taipei City (TW)

(21) Appl. No.: 18/373,649

(22) Filed: Sep. 27, 2023

(30) Foreign Application Priority Data
Nov. 10, 2022 (TW) 111142887

(51) Int. Cl. G05B 19/4155; B23Q 15/12

(52) U.S. Cl. CPC G05B 19/4155; B23Q 15/12; G05B 2219/33099

(57) ABSTRACT

The invention provides a portable CNC machine, including a body and four anchorage bases. The body is put on a surface of a work frame. The body is provided with a machining tool, a processing module and four take-up and pay-off modules, each take-up and pay-off module takes up and pays off a cable, a tail end of each cable is provided with an anchor, and the processing module is connected to and controls the four take-up and pay-off modules. The four anchorage bases are disposed at four corners of the work frame respectively, and stretch and hang the four anchors thereon respectively. The processing module controls the four take-up and pay-off modules to take up and pay off the cables to control the body to freely move on the work frame, and at the same time, the processing module controls the machining tool to carry out a machining operation.

### BACKGROUND OF THE INVENTION

### 1. Field of the Invention

The invention belongs to a CNC machine, and in particular, to a portable CNC machine that is light and easy to carry, easy to configure and set, and can ensure machining precision.

### 2. Description of the Prior Art

Traditional computer numerical control (CNC) machines are mostly large gantry machines, which are structurally complicated, heavy, and bulky, thus requiring a large site for erection. However, lengths and heights of objects-to-be-machined are limited by sizes of the gantry machines, so only objects-to-be-machined placed within working ranges of the gantry machines can be machined, which limits their applications.

In order to seek flexibility of machining operations, a variety of small CNC machines have been introduced to the market in recent years, most of which adopt movable structures and may be used for machining objects-to-be-machined larger than themselves, thereby reducing site or tool limitations to meet more diversified operation needs.

A known small CNC machine is for example a SHAPER ORIGIN hand-held CNC machine, which has a working principle of sticking a positioning tape on a working path to make the machine positioned through vision recognition and assisted by a manual operation for machining, and has the disadvantages that a large amount of tape has to be stuck in advance, a large amount of time is wasted, and accuracy of tape sticking is difficult to control, resulting in a difficulty in maintaining machining precision.

Another small CNC machine is for example a GOLIATH CNC machine, which is characterized by use of a self-propelled vehicle with two sets of external detectors to define a position so as to make the self-propelled vehicle move to machine an object-to-be-machined, which may theoretically realize a machining range of an unlimited size, but has the problems that before starting to work, measuring and positioning have to be repeated for multiple times, then machining can be started, preparatory work is slightly complicated, and universal wheels of the self-propelled vehicle have a risk of slippage, which may affect the machining precision.

Yet another small CNC machine is for example a MASLOW CNC machine, which is arranged in a suspension manner, using two chains to hang a machining tool on a vertical work frame surface, and using the weight of the machining tool and extension and retraction of the two chains to balance control of a machining position, has the advantages of having a small floor area and being capable of using a balance weight to resist a counter-acting force during machining of the machining tool, thus being easy to configure and control, but has the disadvantages that a huge work frame has to be erected in advance and then complicatedly set and adjusted before it can be used, so the operation wastes time and energy, and for the suspension manner using the two chains, the stability is difficult to maintain, which will have an adverse impact on the machining precision.

In view of this, the known small CNC machines have many deficiencies in design, which is difficult to meet the needs of actual machining, so the deficiencies need to be solved urgently.

### SUMMARY OF THE INVENTION

In order to overcome the above disadvantages, an objective of the invention is to provide a portable CNC machine, which is pretty easy to arrange and operate and may meet the needs of most CNC machining.

Another objective of the invention is to provide a portable CNC machine, which may be applied to an object-to-be-machined larger than the machine itself while still maintaining good machining quality.

Yet another objective of the invention is to provide a portable CNC machine, which may be applied to a horizontal or inclined plane machining operation and is suitable enough for most CNC machining operations, thus having an extremely wide range of applications.

A portable CNC machine capable of achieving the foregoing objectives, including a body and four anchorage bases.

The body is put on a surface of a work frame. The body is provided with a machining tool, a processing module and four take-up and pay-off modules, each take-up and pay-off module takes up and pays off a cable, a tail end of each cable is provided with an anchor, and the processing module is connected to and controls the four take-up and pay-off modules.

The anchorage bases are disposed at four corners of the work frame respectively, and stretch and hang the four anchors thereon.

The processing module controls the four take-up and pay-off modules to take up and pay off the cables to control the body to freely move on the work frame, and at same time, the processing module controls the machining tool to carry out a machining operation.

By means of the above composition, a machining method using the portable CNC machine according to the invention includes the steps:
making the four take-up and pay-off modules simultaneously take up the respectively corresponding cables, so that the anchor at the tail end of each cable is taken up until reaching a limit;
inputting a size of the work frame, and automatically calculating, by the processing module, a required extension length of each cable and a usable working range;
mounting the four anchorage bases at the four corners of the work frame, and stretching the four cables, so that the anchors at the tail ends of the four cables are hung on the corresponding anchorage bases respectively;
controlling, by the processing module, the four take-up and pay-off modules to simultaneously take up the respectively corresponding cables until the cables are tightened, at this time, the body being pulled to a center of the work frame that is set as an origin of a machining coordinate; and
inputting a control instruction into the processing module, so that the body drives the machining tool to carry out machining.

In the foregoing structure of the invention, the processing module uses an input device for wired/wireless connection to input a control instruction.

Besides, the body is provided with a card reader that is connected to the processing module, and the card reader is configured to allow a memory card to be inserted, so as to read a control instruction in the memory card and input same into the processing module.

Or, the body is provided with a touch screen, and the touch screen is connected to the processing module to display work information or touched to input a control instruction.

Moreover, the machining tool is positioned on the body in a detachable manner, and different machining tools can be selected for use according to machining demands.

Furthermore, the four or more take-up and pay-off modules and anchorage bases are arranged to provide higher rigidity or a more flexible degree of freedom.

### BRIEF DESCRIPTION OF THE DRAWINGS

FIG. 1 is a structural stereogram of a body of the invention.

FIG. 2 is a structural stereogram of an anchorage base of the invention.

FIG. 3 is a structural block diagram of the invention.

FIG. 4 is a diagram of an embodiment of the invention.

FIG. 5 is a flow chart of a machining method of the invention.

FIG. 6 is a coordinate diagram of cable take-up and pay-off distance computational formulas of the invention.

### DESCRIPTION OF REFERENCE NUMBERS

100: Body
110: Tool fixing frame
120: Processing module
130: Take-up and pay-off module
140: Cable
150: Anchor
160: Card reader
170: Touch screen
200: Anchorage base
210: Clamp
220: Anchor post
300: Machining tool
400: Work frame
500: Input device
600: Memory card

### DETAILED DESCRIPTION OF THE PREFERRED EMBODIMENTS

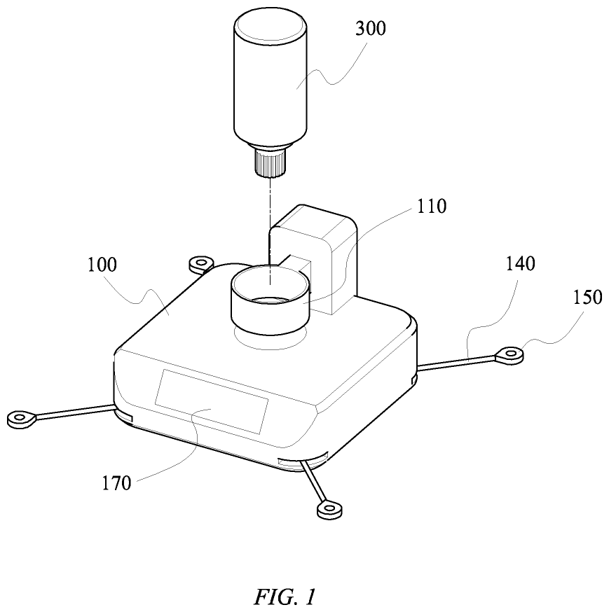

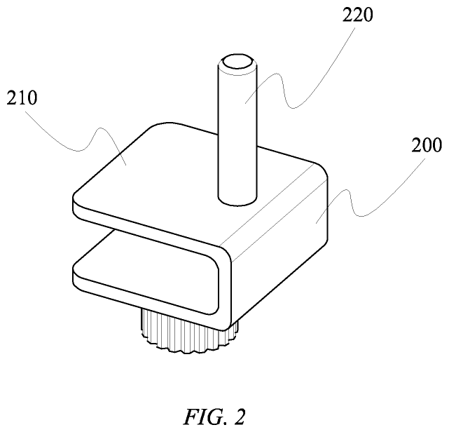

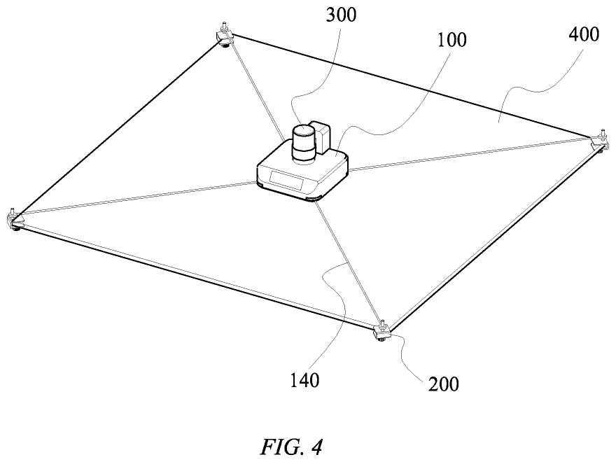

Reference is made to FIG. 1 to FIG. 4, which show a portable CNC machine according to the invention. The portable CNC machine includes a body 100 and four anchorage bases 200. The body 100 is configured to bear a machining tool 300 to move on a surface of a work frame 400, so as to machine an object-to-be-machined on the work frame 400. The four anchorage bases 200 are mounted at four corners of the work frame 400 to position the body 100, so as to ensure the smooth progress of a machining operation.

For a detailed description, the body 100 is put on the surface of the work frame 400. The body 100 is provided with a tool fixing frame 110 to clamp and fix the machining tool 300, the machining tool 300 may be of any type, such as a milling cutter, a graver, a radio knife or other tools, which may be replaced as required for machining, and the machining tool 300 may be an independent device. Or, the body 100 is provided with a processing module 120 to be connected to and control the machining tool 300 to act through the processing module 120.

The body 100 is additionally provided with four take-up and pay-off modules 130 to cooperate with implementation of the four anchorage bases 200. Each take-up and pay-off module 130 takes up and pays off a cable 140, and a tail end of each cable 140 is provided with an anchor 150, so that the four anchors 150 respectively draw the corresponding cables 140 to stretch and finally are hung on the corresponding anchorage bases 200 respectively, so as to complete connection between the body 100 and the four anchorage bases 200. The four take-up and pay-off modules 130 are simultaneously connected to the processing module 120, and take-up and pay-off operations of the cables 140 of the four take-up and pay-off modules 130 are controlled by the processing module 120.

The processing module 120 is a microprocessor or a microcontroller, uses an external input device 500 for wired/wireless connection to input a control instruction, and then controls the four take-up and pay-off modules 130 to guide the body 100 to move for machining. The external device may be a computer, a mobile phone, a tablet computer, or an independent device customized for the invention.

The anchorage bases 200 are provided with clamps 210 to fix the anchorage bases 200 to the corners of the work frame 400. The clamps 210 are provided with anchor posts 220, and the anchor posts 220 are configured to hook the corresponding anchors 150, so as to complete connection between the body 100 and the four anchorage bases 200. The processing module 120 is used to control the four take-up and pay-off modules 130 to take up and pay off the cables 140 and then control the body 100 to freely move on the work frame 400, and at the same time, the processing module 120 controls the machining tool 300 to carry out a machining operation.

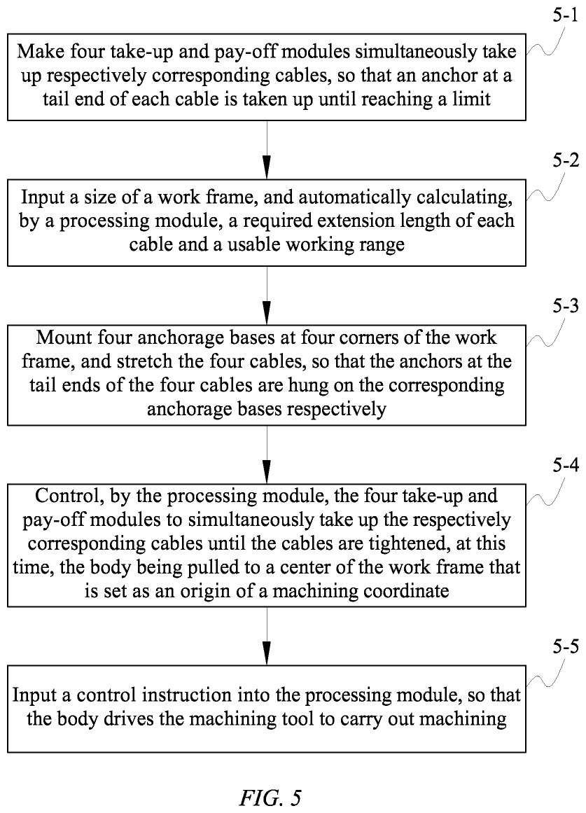

Referring to a flow chart shown in FIG. 5, according to the foregoing structural composition, a machining method using the portable CNC machine according to the invention includes the steps:
5-1. carrying out, by a user, datum setting on the four take-up and pay-off modules 130, where the four take-up and pay-off modules 130 first simultaneously take up the respectively corresponding cables 140, so that the anchor 150 at the tail end of each cable 140 is taken up until reaching a limit, so as to set a mechanical origin;
5-2. inputting a size of the work frame 400, and automatically calculating, by the processing module 120, a required extension length of each cable 140 and a usable working range, actually, where a plurality of extension lengths may be added besides the required length to ensure free movement within the working range;
5-3. mounting the four anchorage bases 200 at the four corners of the work frame 400, and stretching the four cables 140, so that the anchors 150 at the tail ends of the four cables 140 are hung on the corresponding anchorage bases 200 respectively;
5-4. controlling, by the processing module 120, the four take-up and pay-off modules 130 to simultaneously take up the respectively corresponding cables 140 until the cables 140 are tightened, at this time, the body 100 being pulled to a center of the work frame 400 that is set as an origin of a machining coordinate; and
5-5. inputting a control instruction into the processing module 120, so that the body 100 drives the machining tool 300 to carry out machining.

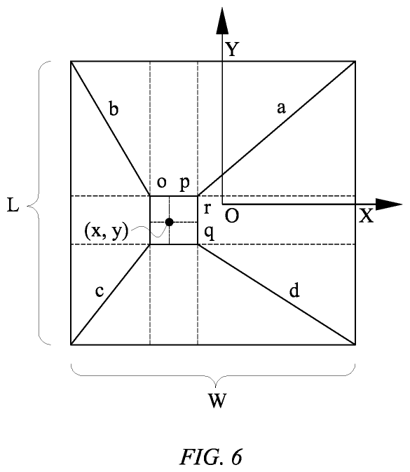

Referring to FIG. 6, take-up and pay-off distances a to d of the four cables 140 according to the invention may be carried out according to the following computational formulas:

$$a = √ [ {( \frac{W}{2} - p - x )}^{2} + {( \frac{L}{2} - r - y )}^{2} ]$$

$$b = √ [ {( \frac{W}{2} - o + x )}^{2} + {( \frac{L}{2} - r - y )}^{2} ]$$

$$c = √ [ {( \frac{W}{2} - o + x )}^{2} + {( \frac{L}{2} - q + y )}^{2} ]$$

$$d = √ [ {( \frac{W}{2} - p - x )}^{2} + {( \frac{L}{2} - q + y )}^{2} ]$$

in the formulas, x, y=machining coordinates of a working point of the machining tool 300 relative to an origin O;
o, p, q, r=distances of cable outlets of the cables 140 of the four take-up and pay-off modules 130 relative to the working point; and
L, W=a length and width of the work frame 400.

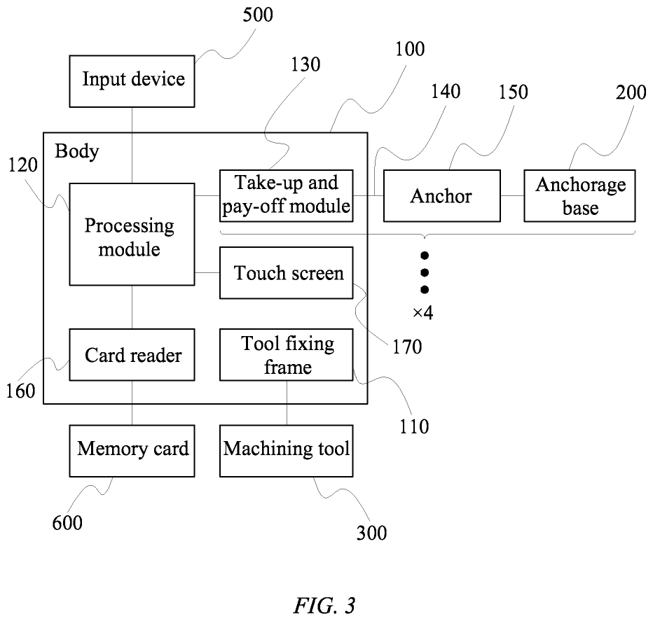

Referring to FIG. 3 again, the control instruction received by the processing module 120 is input by using the input device 500, besides which, the body 100 may also be provided with a card reader 160, the card reader 160 is connected to the processing module 120, and then a memory card 600 is inserted into the card reader 160 to read a control instruction in the memory card 600 and input same into the processing module 120 for controlling.

Besides, the body 100 is provided with a touch screen 170, and the touch screen 170 is connected to the processing module 120 to display work information, such as position coordinates of the body 100, or working time, and may also be used as an input device 500 to input the control instruction in a touch manner.

In addition, the invention mainly uses the cables 140 of the four take-up and pay-off modules 130 to control the position of the body 100. The four take-up and pay-off modules 130 and anchorage bases 200 are arranged, which is the minimum limit to achieve reliable operation of CNC machining, and above this, four or more take-up and pay-off modules 130 and anchorage bases 200 may be arranged. The more take-up and pay-off modules 130 and anchorage bases 200 are used to provide higher rigidity or a more flexible degree of freedom.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A portable CNC machine, comprising:
a body, put on a surface of a work frame, the body being provided with a machining tool, a processing module and four take-up and pay-off modules, each take-up and pay-off module taking up and paying off a cable, a tail end of each cable being provided with an anchor, and the processing module being connected to and controlling the four take-up and pay-off modules; and
four anchorage bases, disposed at four corners of the work frame respectively, and stretching and hanging the four anchors thereon; and
the processing module controlling the four take-up and pay-off modules to take up and pay off the cables to control the body to freely move on the work frame, and at same time, the processing module controlling the machining tool to carry out a machining operation.

2. The portable CNC machine according to claim 1, wherein the processing module uses an input device for wired/wireless connection to input a control instruction.

3. The portable CNC machine according to claim 1, wherein the body is provided with a card reader that is connected to the processing module, and the card reader is configured to allow a memory card to be inserted, so as to read a control instruction in the memory card and input same into the processing module.

4. The portable CNC machine according to claim 1, wherein the body is provided with a touch screen, and the touch screen is connected to the processing module to display work information or touched to input a control instruction.

5. The portable CNC machine according to claim 1, wherein the machining tool is positioned on the body in a detachable manner, and different machining tools can be selected for use according to machining demands.

6. The portable CNC machine according to claim 1, wherein the four or more take-up and pay-off modules and anchorage bases are arranged to provide higher rigidity or a more flexible degree of freedom.

7. A machining method using the portable CNC machine according to claim 1, comprising:
making the four take-up and pay-off modules simultaneously take up the respectively corresponding cables, so that the anchor at the tail end of each cable is taken up until reaching a limit;
inputting a size of the work frame, and automatically calculating, by the processing module, a required extension length of each cable and a usable working range;
mounting the four anchorage bases at the four corners of the work frame, and stretching the four cables, so that the anchors at the tail ends of the four cables are hung on the corresponding anchorage bases respectively;
controlling, by the processing module, the four take-up and pay-off modules to simultaneously take up the respectively corresponding cables until the cables are tightened, at this time, the body being pulled to a center of the work frame that is set as an origin of a machining coordinate; and
inputting a control instruction into the processing module, so that the body drives the machining tool to carry out machining.
